(19) United States
(12) Patent Application Publication
(10) Pub. No.: US 2026/0221328 A1
(43) Pub. Date: Jul. 30, 2026

(54) INDUCTOR ASSEMBLY, APPARATUS FOR GENERATING A MAGNETIC FIELD AND ASSOCIATED METHODS

(71) Applicant: Zimmer MedizinSysteme GmbH, Neu-Ulm (DE)

(72) Inventors: Luka Leon GRIES, Neu-Ulm (DE); Frederik Reinhold VAHRMANN, Ulm (DE)

(21) Appl. No.: 19/147,595

(22) PCT Filed: Jan. 22, 2024
(86) PCT No.: PCT/EP2024/051374

§ 371 Date: Jul. 11, 2025

(30) Foreign Application Priority Data
Jan. 23, 2023 (LU) 503391

(51) Int. Cl. H01F 27/10; H01F 27/02; H01F 27/32; H01F 41/12

(52) U.S. Cl. CPC H01F 27/10; H01F 27/025; H01F 27/324; H01F 41/12

(57) ABSTRACT

An inductor assembly for use in electromagnetic treatment of the human or animal body comprises a housing, an inductor arranged in the housing and electrically insulating material within the housing The electrically insulating material at least partially surrounds the inductor and may be moulded around the inductor. The electrically insulating material at least partially defines a fluid channel for a cooling fluid for cooling the inductor. The fluid channel is located or defined between the housing and the electrically insulating material.

The present invention relates to an inductor assembly, an apparatus for generating a magnetic field, and associated methods for generating a magnetic field, in particular for application to (human or animal) body tissue.

The invention can in particular be used to generate an alternating magnetic field, i.e. a magnetic field whose magnetic field strength varies over time, and in particular a magnetic field whose magnetic field strength reverses its orientation over time. Such alternating magnetic fields can be used to generate a voltage in the body tissue, in particular so as to cause a neural reaction or a cellular physiological reaction in the body tissue, in particular so as to cause a muscle reaction in the body tissue. In some cases, the voltage can be sufficient to cause a therapeutic effect, or some other (desirable) effect in the body tissue, i.e. not necessarily a therapeutic effect, but, for example, an aesthetic effect. In some cases, the voltage can result in a change in cell membrane potential or the strengthening of muscle tissue.

Prior art inductor assemblies of the type described above typically comprise an inductor such as a coil with a set of turns of conductive material such as copper accommodated in a housing. Individual turns of the coil are electrically insulated from one another. In addition, the set of turns is typically embedded in insulating material so that the individual turns are fixed in position relative to one another. In many such inductor assemblies, the coil (or the combination of coil and insulating material) generally has the shape of a flat disc, i.e. a generally cylindrical body (not necessarily of circular cross-section), the diameter of which is (significantly) larger than its height. The coil may have more than one layer of turns one above the other, for example two layers of turns.

Many inductor assemblies of the type described above require cooling. To this end, the sub-assembly of the set of turns and embedding insulating material is placed in the housing, whereby a space is left empty between the sub-assembly and the housing, either only on one side of the “disc” (inductor) or on both sides of the disc. A (liquid or gaseous) cooling fluid may then flow around the sub-assembly in order to cool the sub-assembly.

The inductor assembly is typically used in conjunction with, and connected to, a separate unit, herein referred to as a “main unit”. This is often much larger than the inductor assembly, often a floor-standing unit, whereas the inductor assembly tends to be a hand-held device or a device mounted on a movable arm, in particular a device that can (temporarily) be fixed to a person, e.g. a patient. The main unit can supply electric power and cooling fluid to the inductor assembly. To this end, the inductor assembly is connected to the main unit by an electrical connection and a fluid connection so that the inductor can be powered by the main unit and so that cooling fluid can circulate between the main unit and the inductor assembly. The electrical connection and fluid connection may be accommodated in a common sleeve or similar. The main unit may comprise a cooling device for cooling the cooling fluid.

The inventors have found that simply leaving an empty space on one or both sides of the inductor/disc or around the inductor/disc in order to allow cooling fluid to circulate therethrough may lead to insufficient cooling of the inductor, in particular if this empty space is not entirely filled with cooling fluid-since the cooling of certain regions of the inductor may then depend on the orientation of the inductor assembly. But even if the space next to, or around the inductor/disc is substantially entirely filled with cooling fluid, in some cases the cooling fluid does not uniformly flow over substantially the entire surface of the inductor/disc but may “take a shortcut” from the fluid input into the housing to the fluid output out of the housing, leaving certain areas of the inductor/disc with insufficient circulation of cooling fluid.

Aspects of the present invention seek to address the above issues. Any, some or all of the aspects of the present disclosure discussed below may be considered to constitute aspects of the present invention. Further, the various embodiments and advantages described in connection with any one aspect of the present disclosure may similarly apply to the other aspects of the present disclosure. Each feature disclosed and/or illustrated in the present specification may be incorporated in the invention, whether alone or in combination with any other feature disclosed or illustrated herein, unless such combination is explicitly excluded or technically impossible.

According to a first aspect, the present disclosure provides an inductor assembly comprising:
a housing;
an inductor arranged in the housing; and
electrically insulating material within the housing;
wherein the electrically insulating material at least partially surrounds the inductor; and
wherein the electrically insulating material at least partially defines a fluid channel for a cooling fluid for cooling the inductor.

In the sense of the present disclosure, the term “fluid channel” is preferably intended to be understood to mean a three-dimensional space which is surrounded on at least two, preferably three sides, in particular by the electrically insulating material, whereby cooling fluid is arranged to flow through this three-dimensional space. In particular, a space which is simply left empty between a housing and an inductor/disc of insulating material of an inductor assembly according to the prior art, in particular without any specific structure to guide cooling fluid, is not considered a fluid channel.

Further, a block of electrically insulating material located entirely on one side of an inductor is not considered to “at least partially surround” the inductor. Similarly, two (separate) blocks of electrically insulating material, one of which is located entirely on one side of an inductor and the other of which is located entirely on the other side of the inductor, are also not considered to “at least partially surround” the inductor.

According to an embodiment of the present disclosure, the electrically insulating material is arranged between the housing and the inductor. However, as mentioned above, the electrically insulating material is not located entirely (only) on one side of the inductor between the inductor and the housing, but also at least partially surrounds the inductor.

According to an embodiment of the present disclosure, the electrically insulating material, together with the housing, defines the fluid channel. In other words, the fluid channel can be partially defined by the electrically insulating material and partially by the housing. For example, assuming a generally rectangular cross-section of the fluid channel, the electrically insulating material may define three sides of this rectangular cross-section and the housing may define a fourth side of this rectangular cross-section.

According to an embodiment of the present disclosure, the fluid channel follows a labyrinthine path. For example, the labyrinthine path may have several turns, for example at least partially defining a serpentine pattern. This may ensure that the cooling fluid is guided over a relatively large area while the cross-section of the fluid channel, in particular its width, can be relatively small. For example, the width of the fluid channel may correspond to half (or less) of the width of the body formed by the electrically insulating material, preferably a third (or less) or a quarter (or less) of the width of the body formed by the electrically insulating material.

According to an embodiment of the present disclosure, the inductor is at least partially embedded in the electrically insulating material. In this way, the electrically insulating material can perform several functions: Firstly, it can retain individual turns of the inductor in place, secondly, it can insulate individual turns of the conductor from one another, and thirdly it can (at least partly) define the fluid path.

According to an embodiment of the present disclosure, the electrically insulating material forms a body of substantially uniform composition. In this embodiment, the electrically insulating material is therefore not composed of two or more bodies of different composition, such as a first body of electrically insulating material embedding the inductor (e.g. to perform the first two functions discussed above) and a second body (or further bodies) of electrically insulating material of a different composition and located between the first body of electrically insulating material and the housing in order to define the fluid path (to perform the third function discussed above). This may not only simplify the manufacture of the inductor assembly but may also ensure that the fluid path is located closer to the inductor, which may contribute towards more effective cooling of the inductor.

According to an embodiment of the present disclosure, at least 70%, preferably at least 80%, yet more preferably at least 90% of the surface of the inductor within the housing is in direct contact with the electrically insulating material. According to this embodiment, the majority of the inductor is therefore in direct contact with the electrically insulating material, thereby ensuring that individual turns of the inductor are kept in place and insulated from one another. A small portion of the inductor is, of course, not covered by the electrically insulating material, to allow for external connection to a power supply.

However, individual turns of the inductor or substantially the entire length of the inductor may be covered by a (thin) insulation layer around the conductive material making up the inductor, or around individual wire strands (in the case of a litz wire or a braided wire discussed below), prior to the electrically insulating material being formed around the inductor. For the purpose of the present disclosure, such a (thin) insulation layer is ignored when it comes to assessing what percentage of the surface of the inductor is in direct contact with the electrically insulating material. In other words, for the purpose of the present application, an embodiment in which the entire length of the conductive material making up the inductor (apart from a small portion for connection to a power supply) is covered by a (thin) insulation layer and in which, for example, 90% of the (outer) surface of this (thin) insulation layer is in direct contact with the electrically insulating material is considered to be an embodiment in which 90% of the surface of the inductor is in direct contact with the electrically insulating material. Expressed in a different way, direct contact with the (thin) insulation layer is considered to be a direct contact with the inductor. The thickness of the (thin) insulation layer may, for example, be in a range between (substantially) zero and 2 mm. In some embodiments, the thickness of the (thin) insulation layer is at most 1.5 mm, at most 1 mm, at most 0.7 mm, at most 0.5 mm, at most 0.4 mm, at most 0.3 mm, at most 0.2 mm or at most 0.1 mm.

It is also possible to provide a (thin) insulation layer in the form of electrically insulating film wrapped around the inductor.

According to an embodiment of the present disclosure, the electrically insulating material forms a discrete body at least partially surrounding the inductor and defining the fluid channel. As used herein, the term “discrete body” is intended to mean a coherent body of electrically insulating material which is physically separate from any other body of electrically insulating material-apart from any (thin) insulation layer covering the inductor. In other words, a discrete body of electrically insulating material does not form part of a larger body of electrically insulating material.

According to an embodiment of the present disclosure, the fluid channel comprises first and second fluid channel portions, wherein the inductor is arranged generally between the first and second fluid channel portions. For example, if the electrically insulating material is generally disc-shaped, the first fluid channel portion may be located on one main face of the disc and the second fluid channel portion may be located on the opposite main face of the disc. The inductor may then be located within the disc, in particular embedded within the disc. However, in some embodiments it is possible for the fluid channel to contact the inductor in certain places, i.e. the conductor would then partially be exposed in those places. Additionally, when considering the direction from one main face of the disc to the opposite main face of the disc, in particular generally perpendicular to the two main faces (in the following, this direction will be referred to as the “axial direction”), there may be an overlap between the inductor and one or both of the fluid channel portions. For example, if the disc has a thickness in axial direction of 20 mm and each fluid channel portion has a depth of 6 mm (at least in certain places), the inductor could have a depth of, for example, 10 mm (at least in certain places), resulting in an overlap (in the axial direction) of 1 mm on each side.

According to an embodiment of the present disclosure, the first fluid channel portion is arranged substantially in a first plane and/or the second fluid channel portion is arranged substantially in a second plane, in particular wherein the inductor is arranged substantially in a third plane between the first and second planes, in particular wherein the first, second and third planes are substantially parallel to one another. As used herein, the terms “first plane”, “second plane” and “third plane” are not to be interpreted in a strict, mathematical sense. Instead, these terms refer to a region of a certain depth in the axial direction. Again using the example of the disc having a thickness of 20 mm, the first plane might refer to a region occupying a depth of 6 mm on one side of the disc, the second plane might refer to a region occupying a depth of 6 mm on the opposite side of the disc, and the third plane might refer to a region occupying the middle 10 mm of the disc. Alternatively, the terms “first plane”, “second plane” and “third plane” can also be considered to refer to centre planes (in a mathematical sense) of these depth regions, but also allowing for a certain thickness above and below the centre planes.

According to an embodiment of the present disclosure:
a) the fluid channel further comprises a connecting portion connecting the first fluid channel portion and the second fluid channel portion in series so that fluid, after flowing through the first fluid channel portion, is arranged to flow through the connecting portion and then through the second fluid channel portion. Again considering the electrically insulating material as a disc-shaped body, the connecting portion may extend from one main face of the disc to the opposite main face of the disc in order to connect the first and second fluid channel portions. In particular, the connecting portion may be located at a peripheral portion of the disc. Other locations (not at a peripheral portion of the disc) are also possible, for example at or near the centre of the inductor, but a peripheral position may typically make it easier to accommodate the connecting portion without interfering with the inductor, which may occupy central regions of the disc without extending all the way to the periphery of the disc.

Providing a connecting portion can make it easier to ensure that the cooling fluid can flow past regions on both sides of the disc, in particular substantially evenly, without having to provide separate (external) fluid connections for each of the first and second fluid channel portions (for supplying cooling fluid into and out of the fluid channel portions). In other words, only one pair of external fluid connections may suffice.

According to another embodiment of the present disclosure:
b) the fluid channel further comprises at least one branching portion connecting the first fluid channel portion and the second fluid channel portion in parallel. Such a branching portion may connect an external fluid connection to both the first and second fluid channel portions. A branching portion may be provided either on the input side or the output side of the inductor assembly, or branching portions may be provided on both the input side and the output side of the inductor assembly. If the first and second fluid channel portions are connected in parallel, fluid, after flowing through the first fluid channel portion, is not arranged to flow through the second fluid channel portion (and vice versa)—at least not immediately. Of course, the fluid, having flown through either the first or second fluid channel portion, can flow out of the inductor assembly and into a connected main unit and from there flow back to the inductor assembly to the other of the first and second fluid channel portions.

If a branching portion is provided on each of the input side and the output side of the inductor assembly, one pair of external fluid connections may again be sufficient. In this case, cooling fluid can flow into the inductor assembly and enter the first branching portion at the input side. The fluid flow then splits and flows through the first and second fluid channel portions in parallel. After leaving the first and second fluid channel portions, the separate fluid flows from the first and second fluid channel portions then combine again via the second branching portion, and the combined flow then reaches the external fluid connection at the output side.

In other embodiments in which the first and second fluid channel portions run in parallel, a branching portion can be provided only on the output side, in which case the inductor assembly may have three external fluid connections, for example two (external) inputs (one each for the first and second fluid channel portions) and one (external) output. The separate fluid flows through the first and second fluid channel portions are combined via the branching portion at the output side.

Similarly, a branching portion could be provided only on the input side, in which case the inductor assembly may again have three external fluid connections, i.e. one (external) input and two (external) outputs (one each for the first and second fluid channel portions). Cooling fluid entering the inductor assembly via the (single) input would then split via the branching portion at the input side, and the separate fluid flows through the first and second fluid channel portions then exit the inductor assembly through their respective external outputs.

According to another embodiment of the present disclosure:
c) the inductor assembly comprises a first pair of external connections for the first fluid channel portion and a second pair of external connections for the second fluid channel portion, wherein there is substantially no fluid communication between the first and second fluid channel portions within the housing. In this embodiment, each fluid channel portion has its own input and output (i.e. at least four external fluid connections are required).

A parallel connection of the first and second fluid channel portions may have an advantage over a series connection in that the cooling of the inductor may be more even when a series connection is used, bearing in mind that the temperature of the cooling fluid increases as the cooling fluid flows through the fluid channel. With a series connection, cooling of the inductor in regions close to the very end of the series connection may therefore be (significantly) less effective than at the very beginning of the series connection. On the other hand, a series connection may enable a simpler construction of the inductor assembly since only one external input and one external output is required and no branching portions are necessary.

According to an embodiment of the present disclosure, the fluid channel is arranged generally only on one side of the inductor, in particular wherein the fluid channel is arranged substantially in a first plane and the inductor is arranged substantially in a third plane, in particular wherein the first and third planes are substantially parallel to one another. The comments above in relation to the term “plane” apply in a corresponding manner. Further, it is noted that the term “third plane” (without a second plane being mentioned) is used here primarily for consistency with the embodiment in which three planes are defined.

According to an embodiment of the present disclosure, the electrically insulating material forms a substantially fluid tight seal with the housing, or the inductor assembly further comprises a sealing material between the electrically insulating material and the housing, or at least between portions of the electrically insulating material and the housing. The electrically insulating material itself and/or the housing may therefore have sufficient sealing properties to ensure a substantially fluid tight seal between the electrically insulating material and the housing. Alternatively, or in addition, a sealing material may be provided in addition, in particular a sealing material which has better sealing properties than, for example, the electrically insulating material, for example rubber. The sealing material may be provided in particular along the outline of the fluid channel.

Whether or not an additional sealing material is provided, the electrically insulating material and/or the housing may be curved to increase the pressure between the electrically insulating material and the housing when the inductor assembly is assembled. This may provide a better seal. In particular, the electrically insulating material may be slightly convex at the interface between the electrically insulating material (before assembly with the housing), and/or the housing may be slightly concave at that interface (before assembly with the electrically insulating material).

According to an embodiment of the present disclosure, the inductor comprises a litz wire, a braided wire (in particular of approximately round cross-section) or a single-strand conductor. A single-strand conductor is sometimes also referred to as a solid conductor. The single-strand conductor may be flexible (e.g. a single-strand wire) or a pre-formed, substantially shape-retaining or inflexible solid conductor. Depending on the flexibility of the conductor (in particular wire), holders may be provided to keep the conductor/wire in place and/or in a desired configuration during manufacture of the inductor assembly.

According to an embodiment of the present disclosure, the electrically insulating material comprises polyurethane. Other materials are also possible, for example silicone, epoxy or other plastics materials. More generally, materials can be used which fulfil the following criteria:
1. During manufacture, the material should be sufficiently flexible (or should have a sufficiently low viscosity) so that it can flow around the inductor, in particular around individual turns of the inductor.
2. The material should be able to harden, at least to such an extent that it becomes self-supporting/retains its shape.
3. The material should be compatible with the cooling fluid. For example, if mineral oil or water are to be used as a cooling fluid, the material to be used as electrically insulating material should not be affected by, in particular not react with, the mineral oil or water, respectively.

Depending on the viscosity of the material to be used for the electrically insulating material, the construction of the inductor assembly, in particular of the inductor itself, may need to be adapted. For example, if a material with a relatively high viscosity is to be used (for example some epoxy resins), comparatively large spaces between individual turns of the inductor may be required to ensure that the material with relatively high viscosity can flow around individual turns of the inductor.

According to an embodiment of the present disclosure, the fluid channel comprises:
first and second side walls;
a top wall extending between the first and second side walls; and
a bottom wall generally opposite the top wall and extending between the first and second side walls;
wherein cooling fluid is arranged to flow through the space bounded by the first and second side walls, the top wall and the bottom wall,
wherein the top wall is at least partly defined by the housing and the bottom wall is at least partly defined by the electrically insulating material.

The cross-section of the fluid channel may, for example, resemble a rectangle, in which case one side of the rectangle (“the bottom wall”) would be defined by the electrically insulating material, and the opposite side of the rectangle (“the top wall”) would be defined by the housing. In this regard it is noted that expressions such as “bottom wall”, “top wall” and any other expressions referring to a direction or position are used for illustrative purposes and are not to be understood in a limiting sense. For example, what is referred to herein as “the bottom wall” of the fluid channel would normally be located closer to the inductor than what is referred to herein as “the top wall” of the fluid channel. This is independent of the orientation of the inductor assembly (so that it is possible, depending on the way in which the inductor assembly is held or oriented, that the bottom wall is, for example, above the top wall).

Further, if fluid channel portions are formed on both sides of the inductor, what is referred to herein as “the bottom wall” of the fluid channel (portions) would again be located closer to the inductor than what is referred to herein as “the top wall” of the fluid channel (portions). This can mean, inter alia, that on one side of the inductor, the top wall is located above the bottom wall, and on the other side of the inductor, the bottom wall is located above the top wall.

In addition, other cross-sections, including round or triangular cross-sections or cross-sections of irregular shape—even varying in shape along the length of the fluid channel—are also possible. With some cross-sectional shapes, distinguishing between the top wall, bottom wall and side walls of the fluid channel may be less straightforward than is the case with a rectangular shape. For example, if the fluid channel has a circular cross-section, then the circumference of the circular cross-section may be thought of as being divided into four quarters, whereby the quarter that is closest to the inductor may be regarded as the bottom wall, the quarter that is farthest away from the inductor may be regarded as the top wall, and the remaining two quarters may be regarded as the side walls.

According to an embodiment of the present disclosure:
a) one or both of the first and second side walls are at least partly, in particular entirely, defined by the electrically insulating material; or
b) one or both of the first and second side walls are at least partly, in particular entirely, defined by the housing; or
c) one or both of the first and second side walls are at least partly, in particular entirely, defined by the electrically insulating material and the housing.

In order to manufacture an inductor assembly according to case a), the electrically insulating material can, for example, be moulded in a suitable mould so that the electrically insulating material constitutes one or both of the first and second side walls, or at least part thereof.

Similarly, in order to manufacture an inductor assembly according to case b), the housing can, for example, be moulded in a suitable mould so that the housing constitutes one or both of the first and second side walls, or at least part thereof.

In order to manufacture an inductor assembly according to case c), the electrically insulating material and the housing can, for example, be moulded in respective moulds so that the electrically insulating material and the housing together constitute one or both of the first and second side walls, or at least part thereof.

In each of the above cases a), b) and c), if the side walls are only partly defined by the electrically insulating material or the housing or a combination of the electrically insulating material and the housing, an additional body of material or several additional bodies of material, for example sealing material, can be provided between the electrically insulating material and the housing so as to complete the side walls.

According to an embodiment of the present disclosure, the housing comprises at least first and second materials forming a unitary body, in particular wherein:
the second material is more flexible than the first material, and
the second material is located at an interface with the electrically insulating material.

The unitary body comprising the first and second materials can, for example, be moulded in a two-component moulding process, in particular in a single mould, in particular without removing the material of the housing from the mould before the unitary body has been completed.

The second material can, for example, be moulded onto the first material, or the first material can be overmoulded with the second material.

According to a second aspect, the present disclosure provides a method of manufacturing a sub-assembly for use in the manufacture of an inductor assembly according to the first aspect or any embodiments thereof, comprising:
providing an inductor;
forming electrically insulating material at least partially around the inductor; and
forming a channel in the electrically insulating material such that the channel at least partially defines a fluid channel for a cooling fluid for cooling the inductor.

According to an embodiment of the present disclosure, forming the electrically insulating material at least partially around the inductor comprises:
moulding the electrically insulating material at least partially around the inductor, in particular:
providing a mould;
placing the inductor at least partially in the mould; and
moulding the electrically insulating material at least partially around the inductor, in particular by casting, injection moulding, reaction injection moulding or transfer moulding.

Alternatively, the electrically insulating material can also be formed around the inductor using an additive manufacturing process (3D-printing).

According to an embodiment of the present disclosure, the channel is formed at the same time as the moulding of the electrically insulating material, in particular as part of the moulding of the electrically insulating material. This can make the manufacture particularly efficient. Alternatively, the electrically insulating material may also first be formed, e.g. by moulding, around the inductor without at the same time forming a channel in the electrically insulating material, or only incompletely forming the channel. Subsequently, the electrically insulating material can be further processed in order to form (or complete) the channel, for example by milling the channel.

According to an embodiment of the present disclosure, the method further comprises heating the electrically insulating material, in particular by passing an electric current through the inductor, in particular in order to assist in solidifying, curing or otherwise processing the electrically insulating material. This may speed up the manufacture in cases where the electrically insulating material requires solidifying, curing or similar. In particular, if a mould or similar is used in the manufacturing process, the increased manufacturing speed may free up the mould or similar more quickly so that it may be used more quickly for the manufacture of a further sub-assembly.

According to a third aspect, the present disclosure provides a method of manufacturing an inductor assembly comprising:
manufacturing a sub-assembly according to the method of the second aspect or any embodiments thereof; and
placing the sub-assembly in a housing so as to complete the inductor assembly.

According to a fourth aspect, the present disclosure provides a method of manufacturing an inductor assembly according to the first aspect or any embodiments thereof, comprising: providing an inductor;
forming electrically insulating material at least partially around the inductor so as to produce a sub-assembly comprising the inductor and the electrically insulating material;
forming the housing; and
placing the sub-assembly in the housing;
wherein the sub-assembly and the housing are formed and assembled such that a channel for a cooling fluid for cooling the inductor is formed between the electrically insulating material and the housing.

According to a fifth aspect, the present disclosure provides a method of operating an inductor assembly according to the first aspect or any embodiments thereof, comprising:
using a substance comprising nitrogen, in particular a substance comprising liquid nitrogen, as the cooling fluid and causing the cooling fluid to flow through the fluid channel. Using a substance comprising nitrogen, in particular a substance comprising liquid nitrogen, may provide for particularly effective cooling of the inductor. Alternatively, other refrigerants may be used as the cooling fluid, in particular refrigerants which are easier to handle than (liquid) nitrogen.

Alternatively, or in addition, the inductor assembly may be cooled by causing the cooling fluid to flow through the fluid channel before passing an electric current through the inductor. Such pre-cooling may be used in order for the inductor assembly to reach and/or keep a suitable temperature (more quickly) than without such pre-cooling. Cooling the inductor assembly could, for example, be performed for at least 30 seconds, in particular at least 1, 2 or 3 minutes before passing an electric current through the inductor.

According to a sixth aspect, the present disclosure provides an apparatus for generating a magnetic field, comprising:
an inductor assembly according to the first aspect or any embodiments thereof;
a main unit; and
electric and fluid connections connecting the inductor assembly with the main unit, wherein the main unit comprises:
circuitry for supplying an electric current to the inductor assembly via the electric connection;
a pump for supplying the cooling fluid to the inductor assembly via the fluid connection; and
a cooling device for cooling the cooling fluid.

According to an embodiment of the present disclosure, the apparatus is for use in electromagnetic treatment of the human or animal body. For example, a pulsed electrical current can be passed through the inductor so that the inductor generates a pulsed magnetic field.

According to a seventh aspect, the present disclosure provides a method of operating the apparatus according to the sixth aspect or any embodiments thereof, wherein the method comprises:

bringing the inductor assembly into proximity with body tissue, or bringing the body tissue into proximity with the inductor assembly; and

causing an electrical current to flow through the inductor, thereby causing the inductor to generate the magnetic field so that the magnetic field is present in said body tissue.

Some embodiments of the invention will now be described by way of example only and with reference to the accompanying drawings, in which:

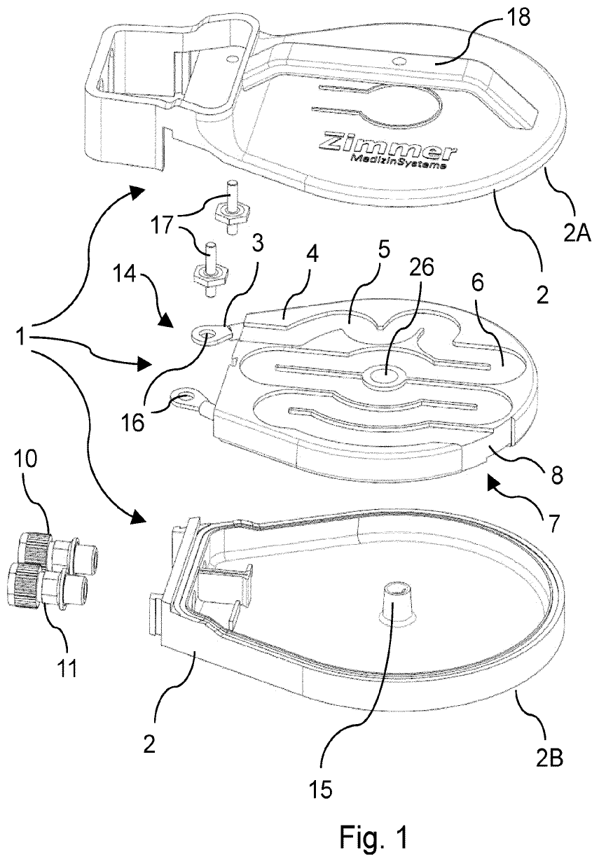

FIG. 1 schematically shows an exploded view of an inductor assembly in accordance with an embodiment of the present invention.

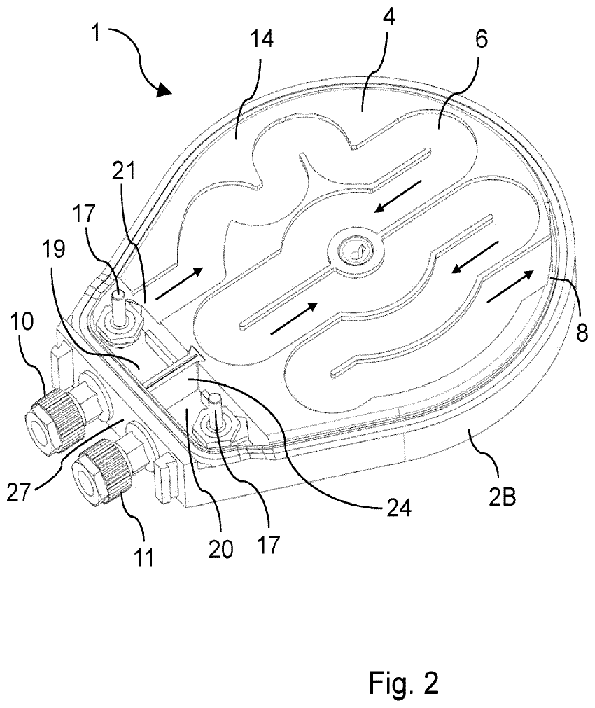

FIG. 2 schematically shows a perspective view of an inductor assembly (with part of the housing removed) in accordance with an embodiment of the present invention.

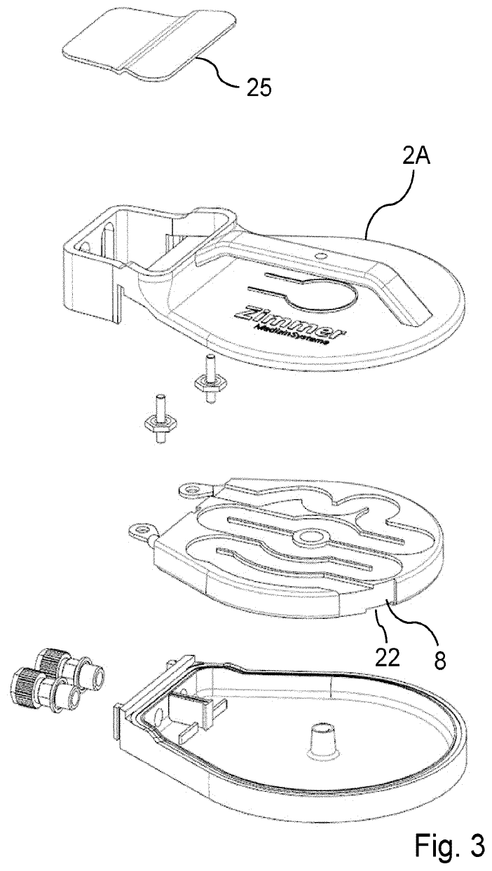

FIG. 3 schematically shows a further exploded view of an inductor assembly in accordance with an embodiment of the present invention.

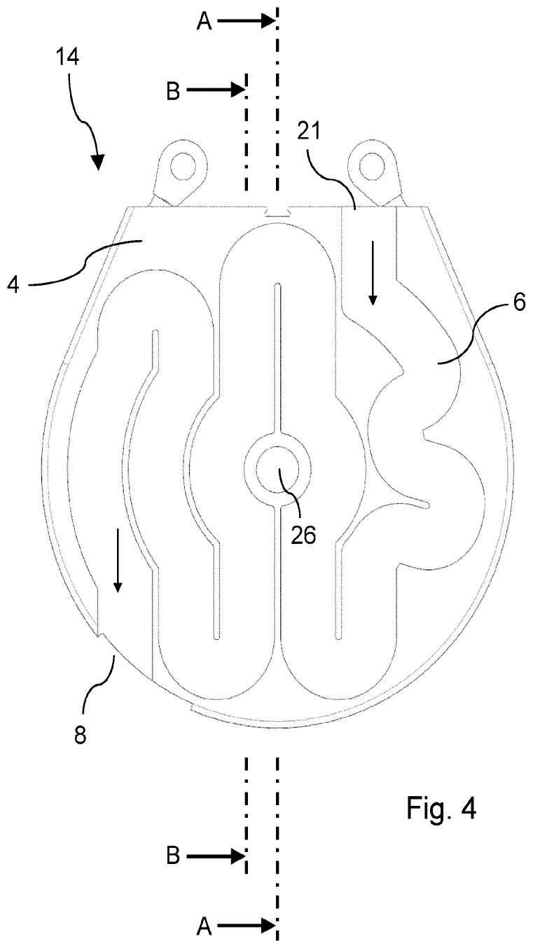

FIG. 4 schematically shows a top view of a sub-assembly for use in an inductor assembly in accordance with an embodiment of the present invention.

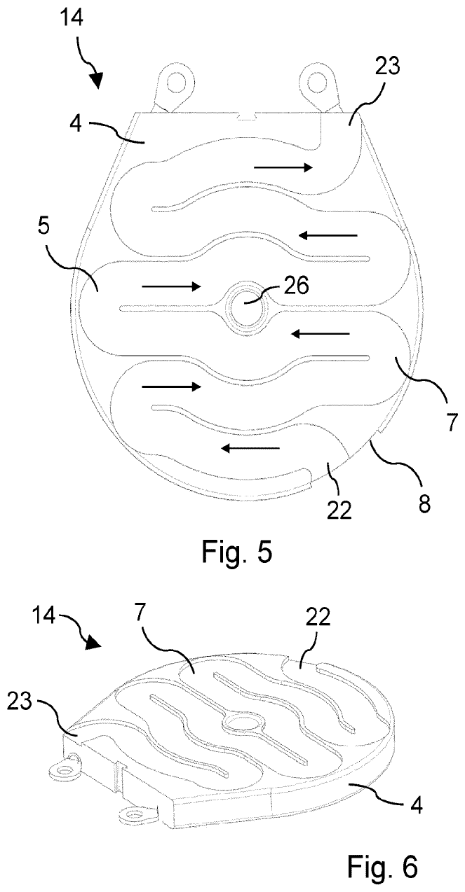

FIG. 5 schematically shows a plan view seen from below of the sub-assembly of FIG. 4.

FIG. 6 schematically shows a perspective view showing the lower side of the sub-assembly of FIG. 4.

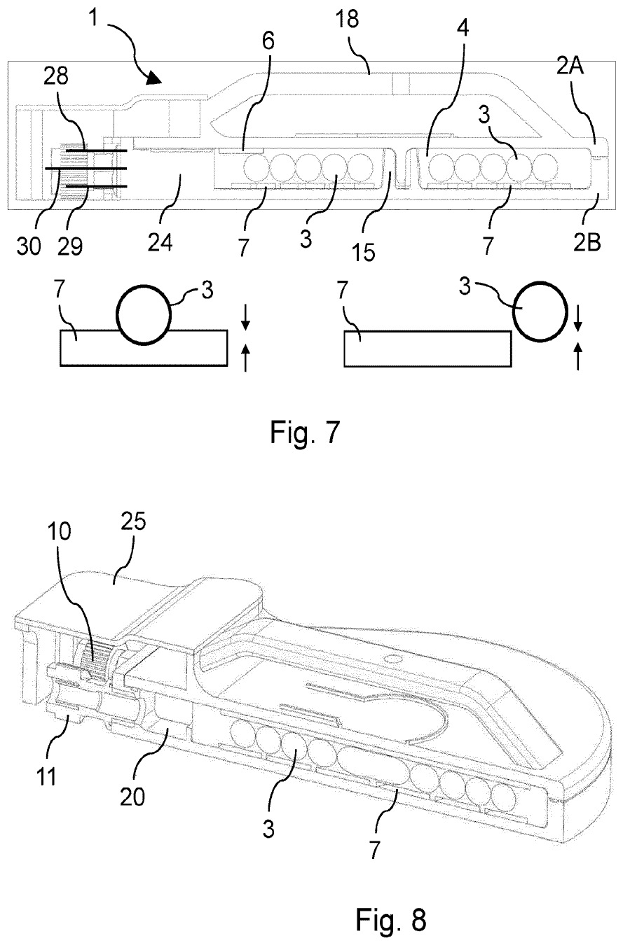

FIG. 7 schematically shows a cross-sectional view of an inductor assembly along a plane corresponding to line A-A in FIG. 4, in accordance with an embodiment of the present invention.

FIG. 8 schematically shows a perspective view of an inductor assembly, partially cut away along a plane corresponding to line B-B in FIG. 4, in accordance with an embodiment of the present invention.

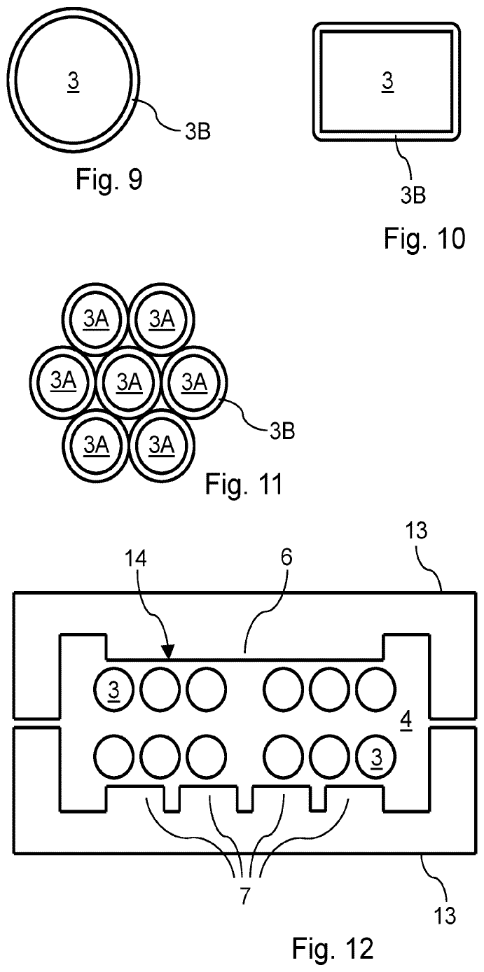

FIG. 9 schematically shows a cross-sectional view of an inductor for use in an inductor assembly in accordance with an embodiment of the present invention.

FIG. 10 schematically shows a cross-sectional view of an inductor for use in an inductor assembly in accordance with an embodiment of the present invention.

FIG. 11 schematically shows a cross-sectional view of an inductor for use in an inductor assembly in accordance with an embodiment of the present invention.

FIG. 12 schematically shows a cross-sectional view of a sub-assembly for use in an inductor assembly in accordance with an embodiment of the present invention, as well as a mould.

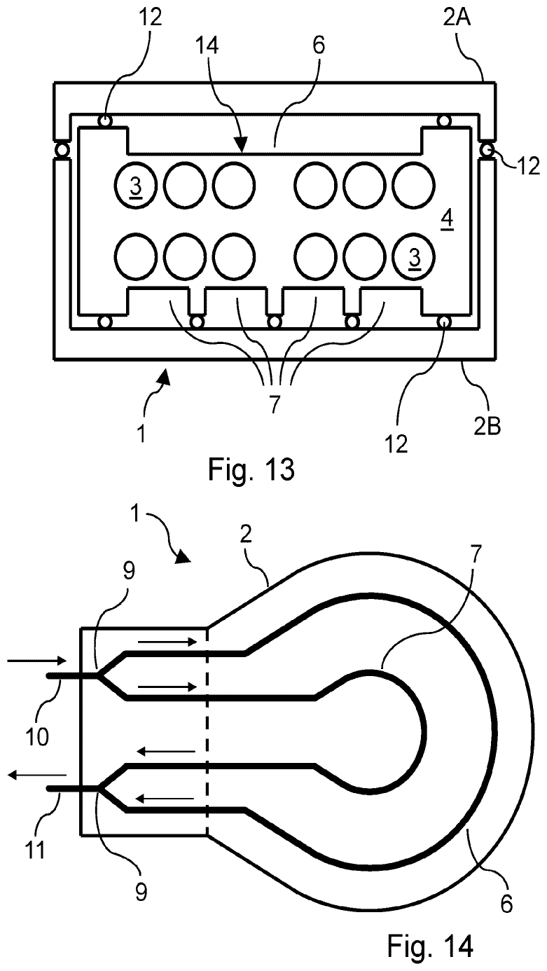

FIG. 13 schematically shows a cross-sectional view of an inductor assembly in accordance with an embodiment of the present invention.

FIG. 14 schematically shows a plan view of an inductor assembly in accordance with an embodiment of the present invention.

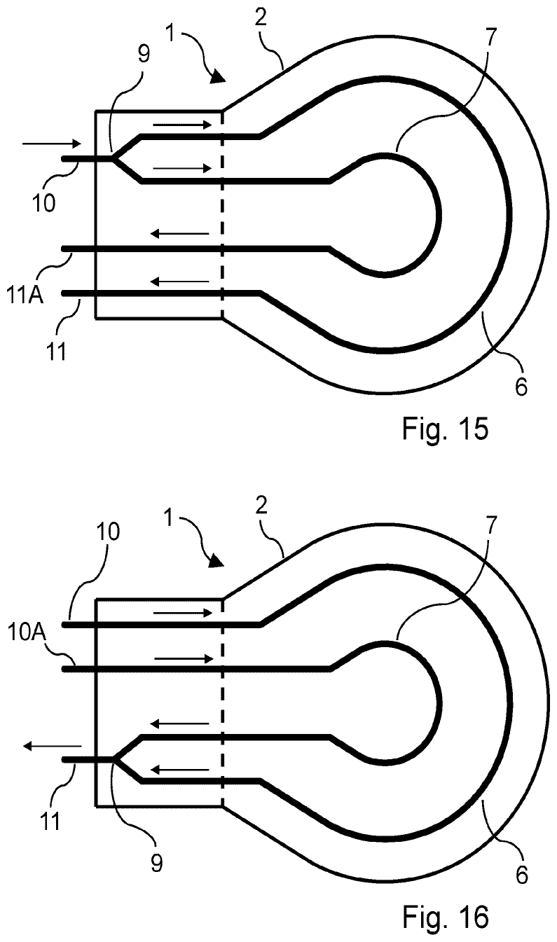

FIG. 15 schematically shows a plan view of an inductor assembly in accordance with an embodiment of the present invention.

FIG. 16 schematically shows a plan view of an inductor assembly in accordance with an embodiment of the present invention.

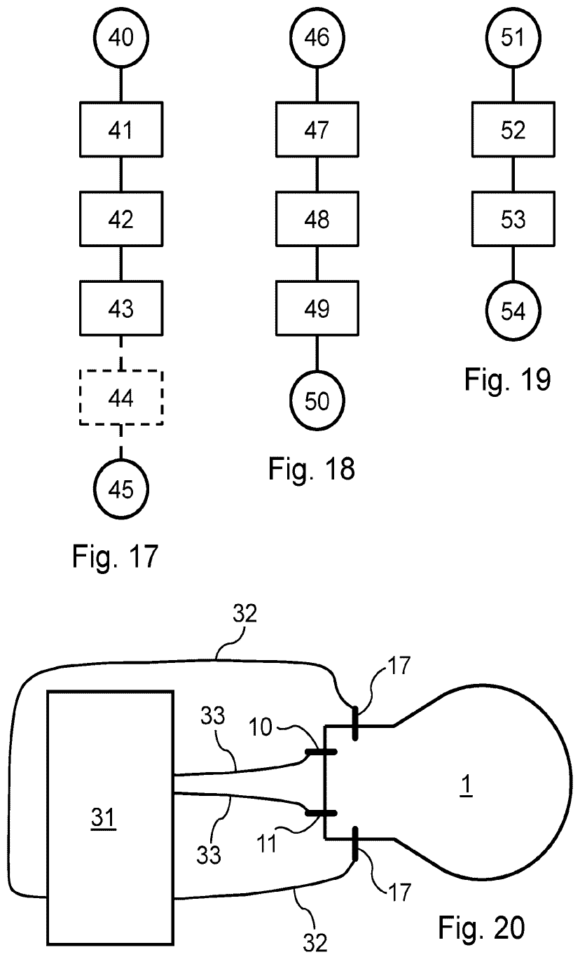

FIG. 17 shows a flowchart illustrating a method in accordance with an embodiment of the present invention.

FIG. 18 shows a flowchart illustrating a method in accordance with an embodiment of the present invention.

FIG. 19 shows a flowchart illustrating a method in accordance with an embodiment of the present invention.

FIG. 20 schematically shows a general view of an apparatus for generating a magnetic field in accordance with an embodiment of the present invention.

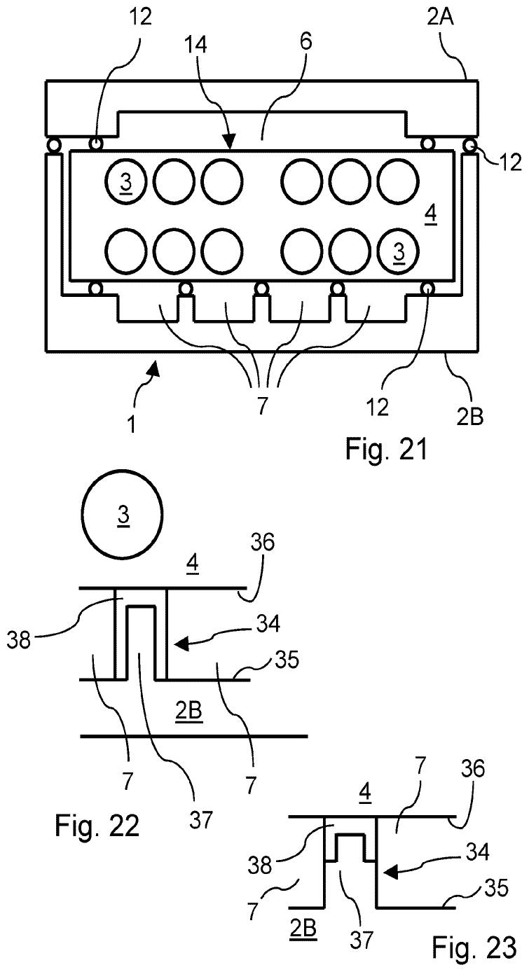

FIG. 21 schematically shows a cross-sectional view of an inductor assembly in accordance with an embodiment of the present invention.

FIG. 22 schematically shows a detailed cross-sectional view of a portion of an inductor assembly in accordance with an embodiment of the present invention.

FIG. 23 schematically shows a detailed cross-sectional view of a portion of an inductor assembly in accordance with an embodiment of the present invention.

To the extent that a component is shown in more than one figure, this component and its function will not necessarily be explained repeatedly.

FIG. 1 schematically shows an exploded view of an inductor assembly 1 in accordance with an embodiment of the present invention. The inductor assembly 1 has three main components: a first housing portion 2A, a second housing portion 2B and a sub-assembly 14. The first housing portion 2A and the second housing portion 2B together form a housing 2. When assembled, housing 2 defines an interior space, in which sub-assembly 14 is accommodated. When assembled, the first housing portion 2A and the second housing portion 2B form a substantially fluid tight seal at their interface so that the interior space between the two housing portions is substantially sealed with respect to the environment (apart from input and output connections, described below).

As shown in FIG. 1, by way of example, the second housing portion 2B may have a locating pin 15, for example approximately at a central position, projecting into the interior space. A cooperating feature (not shown) may be formed on the first housing portion 2A. Together, they may serve to facilitate connecting the two housing portions 2A, 2B, in particular retaining the two housing portions 2A, 2B in the assembled condition. For example, a screw or other fastener (not shown) may extend partially through locating pin 15 to retain first housing portion 2A.

Housing 2 is generally disc-shaped. As can be seen in FIG. 1, the thickness of housing 2 in the axial direction (the axial direction generally corresponding to the orientation of the central axis through locating pin 15) is much smaller than the extent of housing 2 in a plane perpendicular to the axial direction.

The first housing portion 2A has a handle 18, which an operator may grasp in order to hold/manipulate the inductor assembly 1. In use, the (in FIG. 1) lower main face of second housing portion 2B would be placed against a surface of a human or animal, in particular their skin. Whilst FIG. 1 shows the inductor assembly 1 in a particular orientation, with first housing portion 2A at the top and second housing portion 2B at the bottom, the inductor assembly 1 can, in principle, be used in any orientation. Nevertheless, some portions of the inductor assembly 1 will be described in the orientation as shown in FIG. 1.

Sub-assembly 14 is also generally disc-shaped. Sub-assembly 14 comprises an inductor 3 primarily made of conductive material, of which only two ring terminals 16 are visible. The remainder of inductor 3 generally forms a coil with several turns around a central bore 26. Inductor 3 is surrounded by the electrically insulating material 4. Inductor 3 can in particular be embedded in the electrically insulating material 4.

A (fluid) channel 5 is formed in the sub-assembly 14, in particular in the electrically insulating material 4. This fluid channel 5 runs along a path on the surface of insulating material 4. The fluid channel 5 may have several turns and may in particular form a labyrinthine pattern. Although fluid channel 5 is shown with a generally rectangular cross-section, other cross-sections are also possible, for example triangular or semi-circular cross-sections. Further, whilst FIG. 1 shows fluid channel 5 as having a cross-section of substantially constant size and shape, the size and/or shape may also change along the length of the fluid channel 5.

By having several turns, fluid channel 5 is able to cover much of the surface of the upper side of sub-assembly 14 despite having a width that is much smaller than the radius of sub-assembly 14 in a radial plane (perpendicular to the axial direction). Accordingly, when cooling fluid flows along fluid channel 5, the cooling fluid is in contact with the majority of the (upper) surface of sub-assembly 14. This can contribute to substantially uniform cooling of inductor 3 within the electrically insulating material 4.

In the example of FIG. 1, fluid channel 5 formed into the surface of sub-assembly 14 does not have any branches running in parallel, but instead follows a single (curvilinear) path starting near what is shown in FIG. 1 as top left of sub-assembly 14 and ending near what is shown in FIG. 1 as bottom right of sub-assembly 14—as far as it is visible in FIG. 1. However, fluid channel 5 is not only formed into the top surface of sub-assembly 14 but continues in a similar fashion on the bottom surface of sub-assembly 14. Fluid channel 5 therefore comprises a first fluid channel portion 6 formed into the top surface of sub-assembly 14 and a second fluid channel portion 7 (not shown in FIG. 1) formed into the bottom surface of sub-assembly 14. Additionally, a connecting portion 8 is formed into the periphery of sub-assembly 14 extending generally in the axial direction and connecting the first and second fluid channel portions 6, 7. The first and second fluid channel portion 6, 7 are therefore connected in series, via connecting portion 8.

Whilst the figures show a particular pattern of fluid channel 5, other patterns are possible, including patterns having two or more branches running in parallel.

When the two housing portions 2A, 2B and the sub-assembly 14 are assembled to form inductor assembly 1, a substantially fluid tight seal is formed between sub-assembly 14 and first and second housing portions 2A, 2B, leaving only fluid channel 5 free (this is shown more clearly in FIGS. 7, 8 and 13 described below). Accordingly, cooling fluid entering first fluid channel portion 6 (top left of sub-assembly 14) will flow along the entire length of first fluid channel portion 6, then through connecting portion 8 and then along the entire length of second fluid channel portion 7.

The exploded view of FIG. 1 also shows external fluid connections 10, 11. These can be inserted through openings in second housing portion 2B (better shown in FIGS. 2 and 3). The inductor assembly 1 can be connected to external supply lines via the external fluid connections 10, 11. For the purpose of illustration, external fluid connection 10 will be considered to serve as an input, and external fluid connection 11 as an output into/from inductor assembly 1.

FIG. 1 also shows electrical connectors 17—here in the form of two pins which can be inserted into ring terminals 16 and fixed thereto. Electrical connectors 17 enable the inductor assembly 1 to be connected to electrical supply lines in order to supply power to inductor 3.

External fluid connections 10, 11 and electrical connectors 17 may be accommodated in a portion of the first housing portion 2A—in FIG. 1 the left-hand part of first housing portion 2A, which can be covered by a separate lid (not shown in FIG. 1 but shown in FIG. 3).

In an alternative embodiment (not illustrated in the drawings), the connecting portion 8 is not located at a peripheral position but, for example, at a position at or near the centre of the inductor assembly, for example near central bore 26. In such an embodiment, the first and second fluid channel portions 6, 7 may both have a spiral shape, i.e. the first fluid channel portion 6 may start at a peripheral location as shown in FIG. 1, but it would then spiral inwards to the connecting portion 8. From there, on the other side of sub-assembly 14, the second fluid channel portion 7 would lead outwardly in a spiral shape.

FIG. 2 shows the inductor assembly 1 of FIG. 1 in a partially assembled state. That is, the sub-assembly 14 is arranged in the second housing portion 2B, external fluid connections 10, 11 are inserted into end wall 27 of housing portion 2B, and electrical connectors 17 are fixed to ring terminals 16 of inductor 3. Locating pin 15 of the second housing portion 2B is inserted at least partially into central bore 26 of sub-assembly 14. The first housing portion 2A is not shown in FIG. 2.

FIG. 2 shows a separating wall 24 effectively dividing a space within second housing portion 2B (and which is not occupied by sub-assembly 14) into two compartments or chambers 19, 20. These chambers 19, 20 are located generally between the external fluid connections 10, 11 and sub-assembly 14. Assuming that the cooling fluid would enter the inductor assembly 1 via external fluid connection 10 and exit from inductor assembly 1 via external fluid connection 11, chamber 19, into which input fluid connection 10 opens, will be referred to herein as entrance chamber 19, whereas chamber 20, into which output fluid connection 11 opens, will be referred to herein as exit chamber 20.

Entrance chamber 19 also joins onto the start 21 of the first fluid channel portion 6 so that fluid entering via input fluid connection 10 can flow into entrance chamber 19 and from there into the first fluid channel portion 6, as indicated by an arrow in FIG. 2. Apart from that, entrance chamber 19 is substantially sealed in a fluid tight manner once the first housing portion 2A is in place.

Similarly, exit chamber is not only connected to output fluid connection 11 but also to the end 23 of the second fluid channel portion 7 (not shown in FIG. 2, but shown in FIGS. 5 and 6 and discussed below). Apart from that, exit chamber 20 is substantially sealed in a fluid tight manner. As can be appreciated from FIG. 2 (and indicated by arrows), fluid entering via input fluid connection 10 can flow into entrance chamber 19, from there into first fluid channel portion 6, and from there into connecting portion 8. Whilst not shown in FIG. 2, fluid can flow from connecting portion 8 into, and through second fluid channel portion 7, and from there into exit chamber 20. From there, fluid can exit the inductor assembly 1 via output fluid connection 11.

FIG. 3 shows a further exploded view, similar to that of FIG. 1, but from a slightly different perspective. FIG. 3 also shows lid 25 for covering the left-hand part of first housing portion 2A. The connecting portion 8 of fluid channel 5 is also visible, as well as the start 22 of second fluid channel portion 7.

FIG. 4 shows a top view of sub-assembly 14 of FIGS. 1 to 3. Lines with alternating dashes and dots are also shown in FIG. 4. Line A indicates a midplane (perpendicular to the drawing plane) through sub-assembly 14, and line B indicates a plane parallel thereto, somewhat off-centre. The respective cross-sectional views are shown in FIGS. 7 and 8 and will be explained below.

FIG. 5 schematically shows a plan view (seen from below) of the sub-assembly 14 of FIG. 4. The structure of the sub-assembly 14 on the lower side is generally similar to that on the upper side shown in FIG. 4. In particular, a second fluid channel portion 7 is formed in the lower side of sub-assembly 14. This is connected to the first fluid channel portion 6 via the connecting portion 8. The start 22 of the second fluid channel portion 7 is located next to the connecting portion 8. The end 23 of the second fluid channel portion 7 is located at a position which, when the inductor assembly 1 is assembled, leads into the exit chamber 20 shown in FIG. 2.

Like the first fluid channel portion 6, the second fluid channel portion 7 does not have any branches running in parallel, but instead follows a single (curvilinear) path from the start 22 to the end 23 of the second fluid channel portion 7. However, the general pattern or outline of the second fluid channel portion 7 is different from that of the first fluid channel portion 6. Again, patterns other than the pattern shown in FIG. 5 are possible.

FIG. 6 shows a perspective view showing the lower side of the sub-assembly of FIG. 4. This shows the sub-assembly 14 from a different angle when compared with FIG. 5.

FIG. 7 (the main part, top two thirds of the figure) schematically shows a cross-sectional view of an inductor assembly 1 along a plane corresponding to line A-A in FIG. 4, in accordance with an embodiment of the present invention. FIG. 7 shows the inductor assembly 1 comprising first housing portion 2A with handle 18, second housing portion 2B and sub-assembly 14 (not labelled) comprising inductor 3 surrounded by electrically insulating material 4. As already explained, inductor 3 comprises a plurality of turns arranged around locating pin 15, as indicated by a plurality of circles representing cross-sections of individual turns of the inductor 3. In the example shown in FIG. 7, inductor 3 comprises one layer of individual turns of conductive material generally in, or centred around, a (radial) plane 30 (herein also referred to as a third plane). FIG. 7 also includes a sectional representation of first fluid channel portion 6. As can be appreciated from the location of plane A-A in FIG. 4, the first fluid channel portion 6 intersects with the drawing plane of FIG. 7 only in one location, and therefore the first fluid channel portion 6 is shown only in that location in FIG. 7. The first fluid channel portion 6 extends generally in (or centred around) a first (radial) plane 28. Similarly, FIG. 7 also includes a sectional representation of second fluid channel portion 7. As can again be appreciated from the location of plane A-A in FIG. 4, the second fluid channel portion 7 intersects with the drawing plane of FIG. 7 several times, and therefore the second fluid channel portion 7 is shown in several locations in FIG. 7. The second fluid channel portion 7 extends generally in (or centred around) a second (radial) plane 29. The third plane 30 lies between the first plane 28 and the second plane 29, in particular approximately mid-way between these.

As can be seen in FIG. 7, the first fluid channel portion 6 and/or the second fluid channel portion 7 can touch the inductor 3 in one or more locations. That is, the inductor 3 can be exposed in these locations. This is not a problem if a non-conductive fluid is used as the cooling fluid, for example oil. Indeed, the close or direct contact between inductor 3 and the cooling fluid may be preferred since it may result in more effective cooling of inductor 3.

Whilst the main part of FIG. 7 shows inductor 3 in a space defined between the first fluid channel portion 6 and the second fluid channel portion 7, and at most touching these, it is also possible for inductor 3 to overlap with one or both of the two fluid channel portions 6, 7 in the axial direction, according to some variants. This is illustrated in the enlarged portions in the bottom third of FIG. 7. For example, as shown on the left-hand side, inductor 3 may project into one or both fluid channel portions, at least in some places. The overlap in axial direction is indicated between opposing arrows. As shown on the right-hand side, inductor 3 can also occupy an axial position also occupied by the first fluid channel portion 6 or the second fluid channel portion 7, but at different locations in a radial plane—in which case inductor 3 does not project into the first or second fluid channel portion 6, 7. Nevertheless, this also results in an axial overlap, which is again indicated between opposing arrows.

FIG. 8 shows a perspective view of an inductor assembly, partially cut away along a plane corresponding to line B-B in FIG. 4. The view is generally similar to that of FIG. 7. However, not only does FIG. 8 show a perspective view, but the inductor assembly 1 is also cut away in a different plane when compared with FIG. 7. Therefore, whilst the drawing plane of FIG. 7 extends through, and therefore shows, separating wall 24, the drawing plane of FIG. 8 extends through exit chamber 20 and output fluid connection 11. Input fluid connection 10 is also shown.

Whilst the inductor assembly shown in FIGS. 7 and 8 has an inductor that is arranged generally in one radial plane only, variants are also possible in which the inductor has turns of conductive material arranged in two or more radial planes (i.e. radial planes at different axial positions), an example of which is shown in FIGS. 12 and 13.

FIG. 9 schematically shows a cross-sectional view of an inductor 3 for use in an inductor assembly 1 in accordance with an embodiment of the present invention. The conductive material of inductor 3 is covered by a layer of (thin) insulating material 3B, which may prevent short-circuits between individual turns of inductor 3. In the example of FIG. 9, inductor 3 has a circular cross-section.

Alternatively, as shown in FIG. 10, inductor 3 may have a rectangular cross-section. Other cross-sections are also possible.

FIG. 11 schematically shows a cross-sectional view of an inductor 3 for use in an inductor assembly 1 in accordance with an embodiment of the present invention. In this example, inductor 3 is provided as a litz wire, with individual strands 3A of conductive material, each individually covered by a layer of (thin) insulating material 3B. The example shows a litz wire comprising seven individual strands, but a smaller or greater number of individual strands is also possible.

As an alternative to a (non-braided) litz wire, the individual strands may be braided together so as to form a braided wire, in particular a braided wire of (substantially) circular cross-section. Again, the individual strands of the braided wire may be covered by a layer of (thin) insulating material.

The entire litz wire or braided wire may also be covered by a layer of (thin) insulating material (not shown), for example a layer of (artificial) silk, in particular by spinning. In some cases, during manufacture, the (still liquid) insulating material 4 will at least partially be soaked up by such a layer of (artificial) silk, which may result in improved mechanical stability.

FIG. 12 schematically shows a cross-sectional view of a sub-assembly 14 for use in an inductor assembly 1 in accordance with an embodiment of the present invention. FIG. 12 also shows, by way of example, a mould 13 comprising two half shells (top and bottom) for moulding the sub-assembly 14. Sub-assembly 14 is shown somewhat simplified, comprising inductor 3 and electrically insulating material 4. For example, inductor 3 can be placed, during manufacture, within the space defined by the two half shells of mould 13—possibly held in place using holders or similar (not shown). Electrically insulating material 14 is then introduced, for example injected, into mould 13, for example in liquid form, which subsequently solidifies. Inductor 3 is thus embedded within the electrically insulating material 4. Mould 13 also forms the fluid channel 5 (FIG. 12 indicating the first fluid channel portion 6 and the second fluid channel portion 7). Once the electrically insulating material 4 has been moulded (and has solidified), the mould can be removed to reveal sub-assembly 14.

FIG. 13 schematically shows a cross-sectional view of an inductor assembly 1 in accordance with an embodiment of the present invention. This view is similar to that of FIG. 12. However, FIG. 13 shows the mould 13 as having been removed. The sub-assembly 14 has been placed within the housing 2 comprising first housing portion 2A and second housing portion 2B. That is, sub-assembly 14 has first been at least partially introduced into the second housing portion 2B, and then the first housing portion 2A has been placed on second housing portion 2B to complete the housing 2. In addition, FIG. 13 shows sealing material 12 in various locations. By way of example, these may be locations between first housing portion 2A and second housing portion 2B so as to provide a substantially fluid tight housing, and locations along the outline of fluid channel 5 so as to provide a substantially fluid tight seal between individual sections of the fluid channel 5. Without limitation, sealing materials such as NBR (Nitrile Butadiene Rubber) or FKM (Fluorine Kautschuk Material) can be used for this purpose, as well as adhesive materials, in particular multi-component adhesives (e.g. two-component adhesives).

In alternative embodiments, sealing material 12 is not required between sub-assembly 14 and housing 2, in particular if electrically insulating material 4 has sufficiently good sealing properties, such as a sufficient degree of flexibility, so that this can provide a satisfactory seal against housing 2.

Similarly, a seal without (additional) sealing material can also be achieved by heat treatment, for example using a laser or ultrasonic welding. This is particularly suitable at the interface between the two housing portions 2A, 2B, given that this interface is more easily accessible from the outside after the inductor assembly 1 has been assembled.

Whilst the figures described above show inductor assemblies 1 in which a first fluid channel portion 6 on one main face of the sub-assembly 14 is connected in series (via a connecting portion 8) to a second fluid channel portion 7, a variety of other arrangements are possible, including those illustrated in FIGS. 14 to 16. In these, the first fluid channel portion 6 and the second fluid channel portion 7 are connected in parallel. The figures illustrate this in a highly schematically manner. In particular, the two fluid channel portions 6, 7 are represented in the same drawing plane, whilst it is envisaged that they run primarily in different planes (similar to what is shown in FIG. 7). Further, whilst FIGS. 14 to 16 show the two fluid channel portions 6, 7 as a single loop or turn, they may be formed generally in a labyrinthine pattern, as illustrated in FIGS. 1 to 6.

As shown in FIG. 14, the inductor assembly 1 has (only) one external fluid input 10 and (only) one external fluid output 11. These are respectively connected (within the housing 2) to respective branching portions 9 so that fluid flow entering the inductor assembly via external input fluid connection 10 splits and continues as two separate fluid flows within the first fluid channel portion 6 and the second fluid channel portion 7. At the exit side, these two separate fluid flows combine again, via a branching portion 9, and exit the inductor assembly 1 via external output fluid connection 11.

The branching portions 9 described with reference to FIG. 14 (as well as FIGS. 15-16) may be in the form of three connected tubes. Alternatively, the branching portions 9 could be formed by the entrance and exit chambers 19, 20, with the start of each of the first and second fluid channel portions 6, 7 being connected to the entrance chamber 19, and the end of each of the first and second fluid channel portions 6, 7 being connected to the exit chamber 20.

The embodiment shown in FIG. 15 is similar to that of FIG. 14. However, at the exit side, no branching portion 9 is provided. Instead, the separate fluid flows through the first fluid channel 6 and the second fluid channel portion 7 exit the inductor assembly 1 separately, via external output fluid connections 11, 11A. The inductor assembly 1 according to this embodiment therefore has three external fluid connections 10, 11, 11A.

The embodiment shown in FIG. 16 is again very similar to that of FIG. 15. However, this time it is the entrance side which does not have a branching portion 9. Instead, two external input fluid connections 10, 10A are provided at the entrance side. These two separate fluid flows are combined, via a branching portion 9, at the exit side and then exit the inductor assembly 1 via a single external output fluid connection 11.

In yet another embodiment (not shown), two external input fluid connections and two external output fluid connections are provided, without there being any branching portions. The fluid flows into, through and out of inductor assembly 1 therefore remain completely separate and in parallel.

FIG. 17 shows a flowchart illustrating a method in accordance with an embodiment of the present invention. The flowchart shown in FIG. 17 relates to a method of manufacture of a sub-assembly (steps shown in solid lines in FIG. 17) or a method of manufacture of an inductor assembly (steps shown in solid and dashed lines in FIG. 17).

After the start 40 of the method, an inductor (such as inductor 3 described above) is provided in step 41. In step 42, electrically insulating material (such as electrically insulating material 4 described above) is formed at least partially around the inductor. In step 43, a channel is formed in the electrically insulating material such that the channel at least partially defines a fluid channel (such as fluid channel 5) for a cooling fluid for cooling the inductor. Steps 42 and 43 may take place simultaneously, e.g. if electrically insulating material is moulded in a mould that also defines the channel. Thereafter, the method can end (step 45).

In optional step 44, the sub-assembly (manufactured according to steps 41 to 43) is placed in a housing (such as housing 2 described above) so as to form an inductor assembly (such as inductor assembly 1 described above).

FIG. 18 shows a flowchart illustrating a method in accordance with an embodiment of the present invention. The flowchart shown in FIG. 18 relates to a method of operating an inductor assembly (such as inductor assembly 1 described above). After the start 46 of the method, an inductor assembly is provided in step 47. In step 48, the inductor assembly is cooled by causing a cooling fluid to flow through a fluid channel (such as fluid channel 5 described above). Thereafter, in particular when it is considered that a sufficient degree of cooling has been achieved, in step 49, an electric current is passed through the inductor in order to generate a magnetic field. The method can then end (step 50).

FIG. 19 shows a flowchart illustrating a method in accordance with an embodiment of the present invention. The flowchart shown in FIG. 19 relates to a method of operating an inductor assembly (such as inductor assembly 1 described above). After the start 51 of the method, an inductor assembly is provided in step 52. In step 53, the inductor assembly is cooled by causing a cooling fluid to flow through a fluid channel (such as fluid channel 5 described above). In this method, the cooling fluid is a substance comprising nitrogen, in particular a substance comprising liquid nitrogen. Thereafter, the method can end (step 54).

FIG. 20 schematically shows a general view of an apparatus for generating a magnetic field in accordance with an embodiment of the present invention. The apparatus comprises an inductor assembly such as the inductor assembly 1 according to any one of the embodiments described above. In FIG. 20, only the external fluid connections 10, 11 and electrical connectors 17 are shown, but no other details of the inductor assembly 1. FIG. 20 also shows a main unit 31 for supplying electric power and cooling fluid to/from inductor assembly 1. To this end, the electrical connectors 17 are connected to the main unit 31 via respective electric connections 32, such as electric cables 32. External fluid connections 10, 11 are also connected to main unit 31, via fluid connections 33, such as hoses. Electric connections 32 and fluid connections 33 may together be accommodated in a (single) sleeve (not shown).

FIG. 21 shows a further embodiment, which can be regarded as a variant of the embodiment shown in FIG. 13. Most details illustrated in FIG. 21 correspond to those shown in FIG. 13 and will therefore not be described again. In contrast to FIG. 13, the fluid channel 5 with its first and second fluid channel portions 6, 7 is primarily formed in, or defined by, the first and second housing portions 2A, 2B, rather than in the electrically insulating material 4. That is, the fluid channel 5 is still defined (primarily) between the electrically insulating material 4 and the housing 2, but the fluid channel 5 is laterally bounded by (portions of) the housing 2 instead of (portions of) the electrically insulating material 4 (this will be described in more detail with reference to FIGS. 22 and 23). Optionally, sealing material 12 can again be provided between portions of the housing 2 and the electrically insulating material 4.

In a variant of the embodiment of FIG. 21 (not illustrated), the fluid channel is partly formed or defined in the first and second housing portions 2A, 2B and partly in the electrically insulating material 4, optionally with sealing material 12 provided therebetween.

FIG. 22 shows a detailed view of a portion of an inductor assembly 1, according to an embodiment. This embodiment can be regarded as a variant of the embodiment shown in FIG. 21, whereby FIG. 22 shows part of a lower portion of the inductor assembly 1.

FIG. 22 shows electrically insulating material 4 in the region above the uppermost horizontal line. A cross-section of a turn of the inductor 3 is also indicated in this region. The second fluid channel portion 7 is indicated underneath this horizontal line, laterally bounded by a side wall 34. The electrically insulating material 4 defines a bottom wall of the second fluid channel portion 7 (cf. the above explanations regarding the terms “bottom wall” and “top wall” of the fluid channel 5). The second housing portion 2B is indicated between the lowermost horizontal line (effectively the outer surface of the second housing portion 2B) and the second fluid channel portion 7. Accordingly, the second housing portion 2B defines a top wall 35 of the second fluid channel portion 7. The second fluid channel portion 7 (or, more generally, the fluid channel 5) is therefore defined or bounded by two side walls 34 (only one shown in FIG. 22, but cf. FIG. 21 for an illustration of a fluid channel portion 7 bounded by two side walls), a top wall 35 and a bottom wall 36.

The side wall 34 forms an integral part of the second housing portion 2B. In the example shown, the side wall 34 comprises an inner portion of a first material 37 surrounded by an outer portion of a second material 38. The inner portion 37 may be made from the same material as the remainder of the second housing portion 2B. The second material 38 may be moulded over the inner portion 37. In particular, the second material 38 may be more flexible than the first material 37. In this way, the inner portion of the first material 37 may provide sufficient mechanical stability or rigidity for the side wall 34, and the outer portion of the second material 38 may have sealing properties so as to seal against the electrically insulating material 4. Therefore, it is not necessary to provide a separate body of sealing material (such as sealing material 12 shown in FIG. 21) at the interface between side wall 34 (i.e. housing 2) and electrically insulating material 4—although this would additionally be possible.

FIG. 23 shows a further embodiment, which can be regarded as a variant of the embodiment of FIG. 22. Whilst the second material 38 of FIG. 22 covers the entire inner portion 37 (so that, as far as the side wall 34 is concerned, any cooling fluid flowing through the fluid channel 5 will only contact the second material 38 and not the first material 37), the second material 38 of FIG. 23 covers only part of the inner portion 37, in particular a part that is located towards electrically insulating material 4.

Whilst FIGS. 22 and 23 only show a portion of an inductor assembly 1 (corresponding to a portion of the lower part of FIG. 21), it will be appreciated that a similar construction can be used in other parts of the inductor assembly 1, e.g. to form or define the first fluid channel portion 6 in the upper part of FIG. 21.

As an alternative to any of the embodiments or variants described herein and/or illustrated in the drawings, the direction of flow of the cooling fluid could be reversed, i.e. the direction of flow could be opposite to what has been described and/or illustrated. In particular, the first and second channel portions 6, 7 could swap their roles, likewise the entrance and exit chambers 19, 20 etc. Indeed, a better degree of cooling at what, in normal use, would be the side of inductor assembly 1 facing towards a surface of a human or animal (i.e. for example the lower main face of second housing portion 2B, best seen in FIG. 7) can be achieved by causing the cooling fluid first to flow through the channel portion which would normally be located closer to the surface of the human or animal (such as channel portion 7, see e.g. FIG. 7), and then to flow through the channel portion which would normally be located further away from the surface of the human or animal (such as channel portion 6, see e.g. FIG. 7). In most cases, this direction of flow is preferred since, in this way, the side of inductor assembly 1 facing the human or animal can particularly effectively be prevented from getting too hot.

In some embodiments, the inductor assemblies as described herein can be used as a hand-held device, e.g. as a device which is constructed, in particular in terms of its size and weight, that an adult human can easily carry, move and operate the device without the device being additionally supported, e.g. connected to a main unit only by a (flexible) hose, cables etc. Alternatively, the device may be supported, e.g. on a movable arm (with the movable arm being attached to a main unit or some other structure), whereby the device can either be moved by hand (while the device is still supported by the movable arm) or by actuators. Alternatively, the device may be in a fixed spatial relationship to a main unit (whereby the main unit may or may not be movable, e.g. on wheels) or may be in a fixed spatial relationship to some other structure, e.g. integrated into a chair, bed etc.

In some embodiments, the inductor assemblies as described herein may have a diameter between 3 cm and 60 cm. In some embodiments, the diameter is larger than 5 cm, 10 cm or 15 cm. In some embodiments, the diameter is smaller than 50 cm, 40 cm, 30 cm or 20 cm.

In some embodiments, the distance between the inductor 3 and the outer surface of the inductor assembly which is intended to come into contact with a human or animal body (e.g. the lower surface of second housing portion 2B, see FIG. 7, 13, 21 or 22, for example) is smaller than 3 cm, 2 cm, 1.5 cm, 1 cm or 7 mm, and may in particular be substantially 6.5 mm. In some embodiments, the distance between the inductor 3 and this outer surface of the inductor assembly is larger than 4 mm, 5 mm or 6 mm.

In some embodiments, the combined depth of the fluid channel 5 and the thickness of the housing 2 (between the fluid channel 5 and the outer surface of the inductor assembly which is intended to come into contact with a human or animal body)—in FIG. 22, this would be the distance between the uppermost and the lowermost horizontal line—is smaller than 3 cm, 2 cm, 1.5 cm, 1 cm, 7 mm or 6.5 mm and may in particular be substantially 6 mm. In some embodiments, this combined depth is larger than 4 mm, 5 mm or 5.5 mm.

While at least one example embodiment of the present invention has been described above, it has to be noted that a great number of variations thereto exist. Furthermore, it is to be appreciated that the described example embodiments only illustrate non-limiting examples of how the present invention can be implemented and that it is not intended to limit the scope, the application or the configuration of the apparatuses and methods described herein. Rather, the preceding description will provide the person skilled in the art with instructions for implementing at least one example embodiment of the invention, whereby it has to be understood that various changes in the functionality and the arrangement of the elements of the example embodiment can be made without deviating from the subject-matter defined by the appended claims and their legal equivalents.

### LIST OF REFERENCE SIGNS

1 inductor assembly
2 housing
2A first housing portion
2B second housing portion
3 inductor
3A individual strands of (litz wire) inductor
3B (thin) insulating material
4 electrically insulating material
5 fluid channel
6 first fluid channel portion
7 second fluid channel portion
8 connecting portion
9 branching portion
10, 10A external fluid connection(s) (input)
11, 11A external fluid connection(s) (output)
12 sealing material
13 mould
14 sub-assembly
15 locating pin
16 (ring) terminals
17 electrical connectors
18 handle
19 entrance chamber
20 exit chamber
21 start of first fluid channel portion
22 start of second fluid channel portion
23 end of second fluid channel portion
24 separating wall
25 lid
26 central bore
27 end wall
28 first plane
29 second plane
30 third plane
31 main unit
32 electric connection, cable(s)
33 fluid connection, hose(s)
34 side wall
35 top wall
36 bottom wall
37 first material
38 second material
40-54 method steps

1. An inductor assembly comprising:
a housing;
an inductor arranged in the housing; and
electrically insulating material within the housing;
wherein the electrically insulating material at least partially surrounds the inductor; and
wherein the electrically insulating material at least partially defines a fluid channel for a cooling fluid for cooling the inductor.

2. The inductor assembly according to claim 1, wherein the electrically insulating material is arranged between the housing and the inductor.

3. The inductor assembly according to claim 1, wherein the electrically insulating material, together with the housing, defines the fluid channel.

4. The inductor assembly according to claim 1, wherein the fluid channel follows a labyrinthine path.

5. The inductor assembly according to claim 1, wherein the inductor is at least partially embedded in the electrically insulating material.

6. The inductor assembly according to claim 1, wherein the electrically insulating material forms a body of substantially uniform composition.

7. The inductor assembly according to claim 1, wherein at least 70%, preferably at least 80%, yet more preferably at least 90% of the surface of the inductor within the housing is in direct contact with the electrically insulating material.

8. The inductor assembly according to claim 1, wherein the electrically insulating material forms a discrete body at least partially surrounding the inductor and defining the fluid channel.

9. The inductor assembly according to claim 1, wherein the fluid channel comprises first and second fluid channel portions, wherein the inductor is arranged generally between the first and second fluid channel portions.

10. The inductor assembly according to claim 9, wherein the first fluid channel portion is arranged substantially in a first plane and/or the second fluid channel portion is arranged substantially in a second plane, in particular wherein the inductor is arranged substantially in a third plane between the first and second planes, in particular wherein the first, second and third planes are substantially parallel to one another.

11. The inductor assembly according to claim 9, wherein:
a) the fluid channel further comprises a connecting portion connecting the first fluid channel portion and the second fluid channel portion in series so that fluid, after flowing through the first fluid channel portion, is arranged to flow through the connecting portion and then through the second fluid channel portion, or
b) the fluid channel further comprises at least one branching portion connecting the first fluid channel portion and the second fluid channel portion in parallel, or
c) the inductor assembly comprises a first pair of external connections for the first fluid channel portion and a second pair of external connections for the second fluid channel portion, wherein there is substantially no fluid communication between the first and second fluid channel portions within the housing.

12. The inductor assembly according to claim 1, wherein the fluid channel is arranged generally only on one side of the inductor, in particular wherein the fluid channel is arranged substantially in a first plane and the inductor is arranged substantially in a third plane, in particular wherein the first and third planes are substantially parallel to one another.

13. The inductor assembly according to claim 1, wherein the electrically insulating material forms a substantially fluid tight seal with the housing, or wherein the inductor assembly further comprises a sealing material between the electrically insulating material and the housing, or at least between portions of the electrically insulating material and the housing.

14. The inductor assembly according to claim 1, wherein the inductor comprises a litz wire, or a single-strand conductor.

15. The inductor assembly according to claim 1, wherein the electrically insulating material comprises polyurethane, silicone, epoxy or other plastics materials.

16. The inductor assembly according to claim 1, wherein the fluid channel comprises:
first and second side walls;
a top wall extending between the first and second side walls; and
a bottom wall generally opposite the top wall and extending between the first and second side walls;
wherein cooling fluid is arranged to flow through the space bounded by the first and second side walls, the top wall and the bottom wall,
wherein the top wall is at least partly defined by the housing and the bottom wall is at least partly defined by the electrically insulating material.

17. The inductor assembly according to claim 16, wherein:
a) one or both of the first and second side walls are at least partly, in particular entirely, defined by the electrically insulating material; or
b) one or both of the first and second side walls are at least partly, in particular entirely, defined by the housing; or
c) one or both of the first and second side walls are at least partly, in particular entirely, defined by the electrically insulating material and the housing.

18. The inductor assembly according to claim 17, wherein the housing comprises at least first and second materials forming a unitary body, in particular wherein:
the second material is more flexible than the first material, and
the second material is located at an interface with the electrically insulating material.

19. A method of manufacturing a sub-assembly for use in the manufacture of an inductor assembly according to claim 1, comprising:
providing an inductor;
forming electrically insulating material at least partially around the inductor; and
forming a channel in the electrically insulating material such that the channel at least partially defines a fluid channel for a cooling fluid for cooling the inductor.

20. The method according to claim 19, wherein forming the electrically insulating material at least partially around the inductor comprises:
moulding the electrically insulating material at least partially around the inductor, in particular:
providing a mould;
placing the inductor at least partially in the mould; and
moulding the electrically insulating material at least partially around the inductor, in particular by casting, injection moulding, reaction injection moulding or transfer moulding.

21. The method according to claim 20, wherein the channel is formed at the same time as the moulding of the electrically insulating material, in particular as part of the moulding of the electrically insulating material.

22. The method according to claim 19, further comprising heating the electrically insulating material, in particular by passing an electric current through the inductor, in particular in order to assist in solidifying, curing or otherwise processing the electrically insulating material.

23. A method of manufacturing an inductor assembly comprising:
manufacturing a sub-assembly according to the method of claim 19; and
placing the sub-assembly in a housing so as to complete the inductor assembly.

24. A method of manufacturing an inductor assembly according to claim 1, comprising:
providing an inductor;
forming electrically insulating material at least partially around the inductor so as to produce a sub-assembly comprising the inductor and the electrically insulating material;
forming the housing; and
placing the sub-assembly in the housing;
wherein the sub-assembly and the housing are formed and assembled such that a channel for a cooling fluid for cooling the inductor is formed between the electrically insulating material and the housing.

25. A method of operating an inductor assembly according to claim 1, comprising:
using a substance comprising nitrogen, in particular a substance comprising liquid nitrogen, as the cooling fluid and causing the cooling fluid to flow through the fluid channel; and/or
cooling the inductor assembly by causing the cooling fluid to flow through the fluid channel before passing an electric current through the inductor.

26. An apparatus for generating a magnetic field, comprising:
an inductor assembly according to claim 1;
a main unit; and
electric and fluid connections connecting the inductor assembly with the main unit, wherein the main unit comprises:
circuitry for supplying an electric current to the inductor assembly via the electric connection;
a pump for supplying the cooling fluid to the inductor assembly via the fluid connection; and
a cooling device for cooling the cooling fluid.

27. The apparatus according to claim 26, wherein the apparatus is for use in electromagnetic treatment of the human or animal body.

28. A method of operating the apparatus of claim 27, wherein the method comprises:
bringing the inductor assembly into proximity with body tissue, or bringing the body tissue into proximity with the inductor assembly; and
causing an electrical current, in particular a pulsed electrical current, to flow through the inductor, thereby causing the inductor to generate the magnetic field so that the magnetic field is present in said body tissue.
